(19) United States
(12) Patent Application Publication
(10) Pub. No.: US 2009/0175453 A1
(43) Pub. Date: Jul. 9, 2009

(54) STORAGE APPARATUS AND ENCRYPTED DATA PROCESSING METHOD

(75) Inventors: Takahiro Shinbori, Kawasaki (JP); Hideaki Tanaka, Kawasaki (JP); Shigenori Yanagi, Kawasaki (JP); Katsuhiko Takeuchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/260,415

(22) Filed: Oct. 29, 2008

(30) Foreign Application Priority Data
Oct. 30, 2007 (JP) 2007-281584

(51) Int. Cl. H04L 9/06

(52) U.S. Cl. 380/277

(57) ABSTRACT

A storage apparatus has an encryption key updater for configuring an updated encryption key and identification information thereof, an encryptor for encrypting data by a specific unit according to the encryption key, a storage for adding the identification information to the encrypted data and storing the data and the identification information onto a recording medium, a reader for reading the encrypted data and the identification information, a judge for judging whether the identification information read by the reader matches the identification information configured by the encryption key updater, and a decryptor for decrypting the encrypted data and outputting the decrypted data where the judge judges that the identification information matches the identification information configured by the encryption key updater.

### CROSS-REFERENCE TO RELATED APPLICATIONS

This application is based upon and claims the benefit of priority of the prior Japanese Patent Application No. 2007-281584, filed on Oct. 30, 2007, the entire contents of which are incorporated by reference herein.

### BACKGROUND

The application relates to a storage apparatus and an encrypted data processing method for decrypting encrypted data stored.

There have been two information protection methods known as file encryption and drive encryption. File encryption encrypts individual file in which data are stored. Whereas, drive encryption encrypts all data stored in a storage apparatus, i.e., a hard disk. Since drive encryption encrypts all data to be stored in the hard disk automatically without user intervention, omission of encrypting files may be prevented.

In drive encryption, it is more preferable to update encryption keys periodically to enhance security. Should the encryption key be stolen, data are encrypted according to a new encryption key.

Japanese Unexamined Patent Application Publication No. 2004-201038 discloses a data storage apparatus, an information processor having the data storage apparatus, and a data processing method and data processing program for encrypting data to be stored and encryption keys of the data where user authentication and data encryption is used concurrently.

However, updating the encryption keys makes differentiating data encrypted according to an old encryption key from data encrypted according to a new encryption key difficult. Thus, the data encrypted according to the old encryption key are decrypted and read according to the new encryption key.

### SUMMARY

The application is disclosed to solve the issues described above. An object of the present application is to provide a storage apparatus and an encrypted data processing method to prevent decrypting and outputting data encrypted according to the old encryption key with the new encryption key.

According to the present application, a storage apparatus for storing data onto a recording medium has an encryption key updater for configuring an updated encryption key and identification information thereof, an encryptor for encrypting data by a specific unit according to the encryption key configured by the encryption key updater, a storage for adding the identification information configured by the encryption key updater to the data encrypted by the encryptor and storing the encrypted data and the identification information onto the recording medium, a reader for reading the encrypted data stored by the storage and the identification information added to the encrypted data, a judge for judging whether the identification information added to the encrypted data read by the reader matches the identification information configured by the encryption key updater, and a decryptor for decrypting the encrypted data according to the encryption key configured by the encryption key updater and outputting the decrypted data where the judge judges that the identification information added to the encrypted data by the encryptor matches the identification information configured by the encryption key updater.

The above-described embodiments of the present application are intended as examples, and all embodiments of the present application are not limited to including the features described above.

### BRIEF DESCRIPTION OF THE DRAWINGS

FIG. 1 illustrates a structure of a magnetic disk apparatus according to the first embodiment;

FIG. 2 illustrates a structure of sectors formed on the recording media in which data are stored;

FIG. 3 is a flow chart illustrating the encryption key update process;

FIG. 4 is a flow chart illustrating the configuration process;

FIG. 5 is a flow chart illustrating the encryption process;

FIG. 6 is a flow chart illustrating an encryption key identification process;

FIG. 7 is an encryption key update history table according to the second embodiment;

FIG. 8 is a flow chart illustrating a re-encryption process according to the second embodiment;

FIG. 9 is an encryption key type table according to the third embodiment; and

FIG. 10 is a flow chart illustrating an encryption key identification process according to the third embodiment.

### DETAILED DESCRIPTION OF THE PREFERRED EMBODIMENTS

Reference may now be made in detail to embodiments of the present application, examples of which are illustrated in the accompanying drawings, wherein like reference numerals refer to like elements throughout.

Embodiments of the present application are disclosed with reference to the accompanying drawings.

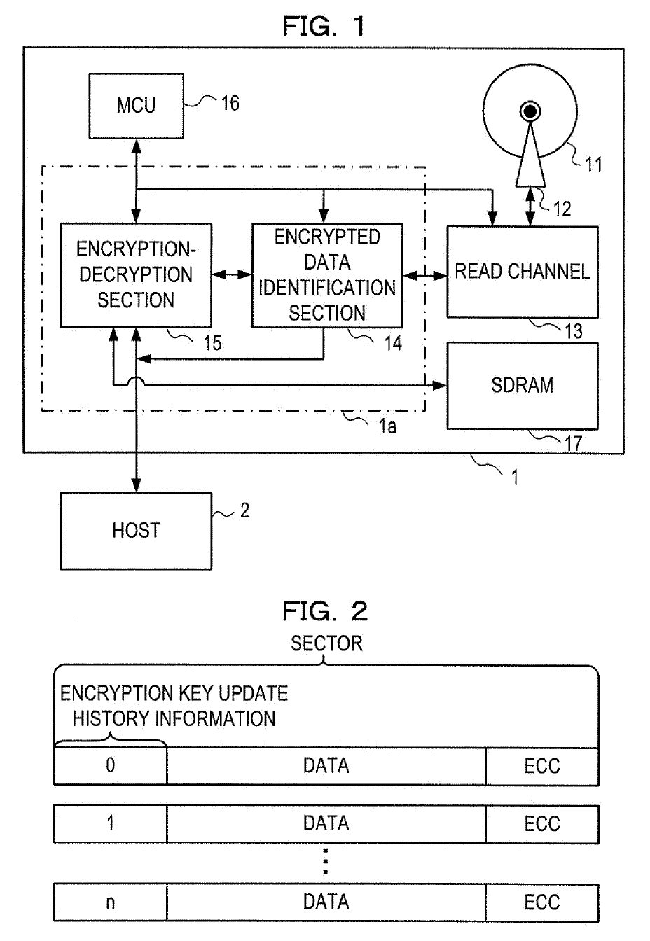

First, the structure of the magnetic disk apparatus according to the first embodiment of the present application is disclosed. FIG. 1 illustrates the structure of the magnetic disk apparatus according to the first embodiment.

The storage apparatus, a magnetic disk apparatus 1, communicates with a host 2 as shown in FIG. 1. The magnetic disk apparatus 1 has recording media, media 11; heads 12; a read channel 13 serving as the reader and the storage; a hard disk controller (HDC) 1a; a micro control section (MCU) 16 having the encryption key updater and the history updater; and a synchronous dynamic random access memory (SDRAM) 17. The HDC 1a has: the judge, an encrypted data identification section 14; and an encryption-decryptor 15 serving as the encryptor and the decryptor.

The media 11 may be a perpendicular magnetic recording media or a longitudinal magnetic recording media. The media 11 have system areas in their recording areas. The encryption key update history information later described and encryption keys associated with the encryption key update history information are stored in the system areas. The heads 12 write data onto and read data from the media 11. The read channel 3 converts digital signals to be written onto the media 11 with the heads 12 into analog signals and reconverts analog signals read from the media 11 with the heads 12 into digital signals.

The encrypted data identification section 14 judges whether the encryption key of the data stored in the medium 11 matches the updated encryption key. The encryption-decryptor 15 encrypts data stored and decrypts data read out.

The MCU 16 controls the read channel 13, the encrypted data identification section 14 and the encryption-decryptor 15 according to commands issued from the host 2 or with various programs. The MCU 16 may be a CPU or a MPU. The SDRAM 17 buffers data transmitted with the host 2.

First, the encryption key update history information that is added to data will be described. FIG. 2 illustrates the structure of the sectors in which data are stored.

Each sector stores encrypted data encrypted by the encryption-decryptor 15, an error correcting code (ECC) and encryption key update history information representing an encryption key in bit count, which encrypts the data as shown in FIG. 2. Where the encryption key is updated n times, the value of the encryption key update information will be n. Where a value of encryption key update history information stored in a sector is “0”, the data stored in the sector is encrypted according to an initial encryption key. Where a value of encryption key update history information stored in a sector is “1”, the data stored in the sector are encrypted according to the first updated encryption key. In embodiments of the present application, where a value of encryption key update history information is “n”, the data stored in the sector are encrypted according to the latest encryption key.

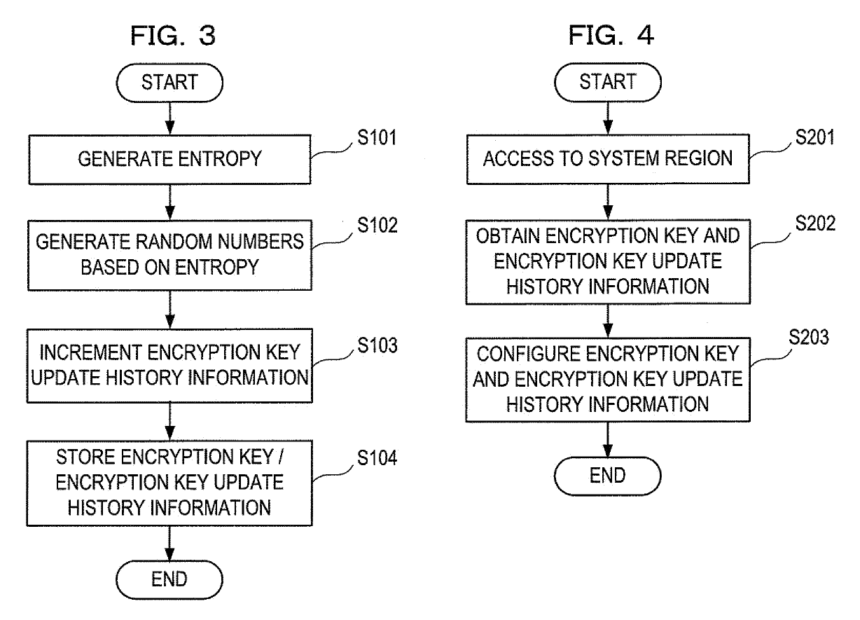

Second, the encryption key update process executed by the magnetic disk apparatus according to the embodiments of the present application will be described. FIG. 3 is the flow chart illustrating the encryption key update process. The magnetic disk apparatus executes the encryption key update process on receiving a command to update an encryption key issued by the host as shown in FIG. 3.

The MCU 16 generates entropy on receiving the command from the host 2, in operation S101. Then random numbers are generated based on the entropy in operation S102. In operation S103, the latest encryption key update history information is read from the system area of the medium 11 and the information is incremented. In operation S104, the generated random numbers are used as an encryption key and the encryption key is associated with the incremented encryption key update history information and the encryption key and the encryption key update history information are stored in the system area of the medium 11.

Before storing the encryption key in the system area of the medium 11, the encryption key itself is encrypted. The encryption key and the encryption key update history information stored in the system area are read by the MPU through the read channel and configured in the HDC. Hereinafter, the configuration process will be explained. FIG. 4 is the flow chart illustrating the configuration process.

When the magnetic disk apparatus 1 is activated, the MCU 16 access to the system area of the medium with head 12 through read channel 13 in operation S201. In operation S202, the encryption key update history information is read from the system area. The encryption key update history information corresponding to the latest encryption key is configured in the HDC 1a in an encryption key configuration operation, S203.

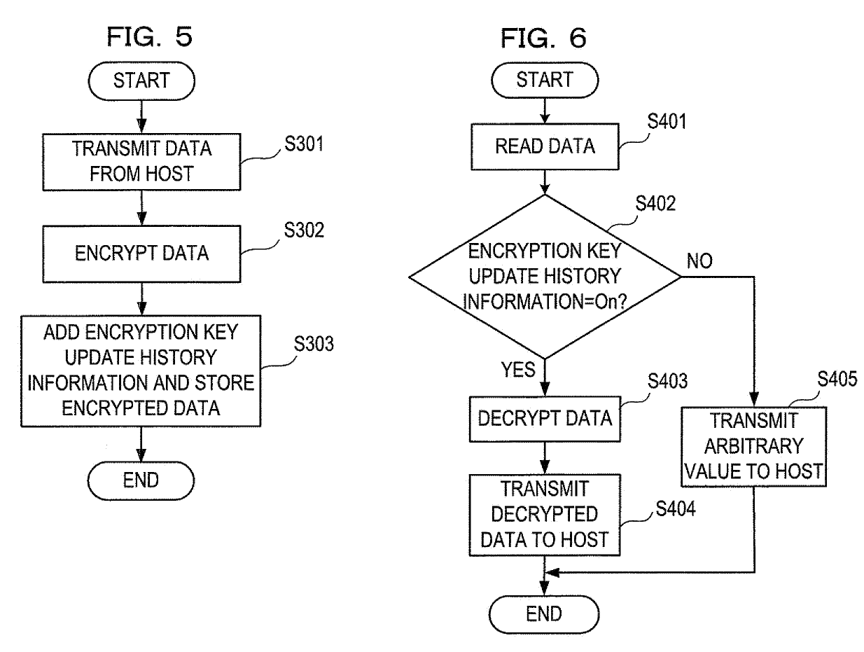

The encryption-decryptor 15 encrypts data transmitted from the host 2 according to the encryption key configured in the HDC 1a as described above. Hereinafter, the encryption process will be described. FIG. 5 is the flow chart illustrating the encryption process.

First, the encryption-decryptor 14 included in the HDC 1a obtains data transmitted from the host 2 in operation S301. In the encryption operation, S302, the data are encrypted and stored by sector according to the encryption key configured. Then the configured encryption key update history information and an ECC are added to the data by sector with the head 12 through the read channel 13 in the storing operation, S303.

The encrypted and stored data are checked against the encryption key update history information configured in the HDC 1a to confirm whether the encryption key used in encrypting the data matches the latest encryption key. The encryption key identification process executed by the HDC 1a will be described. FIG. 6 is the flow chart illustrating the encryption key identification process. The magnetic disk apparatus executes the encryption key identification process on receiving a command to require data issued by the host as shown in FIG. 6.

The MCU 16 reads the data to which the encryption key identification information is added by sector from the medium 11 with the head 12 through the read channel 13 in the reading operation, S401. In the judgment operation, S402, the judge judges whether a value of the encryption key identification information added to the data by sector match a value of the encryption key identification information n configured in the HDC 1a.

Where the value of the encryption key identification information n added to the data by sector is confirmed to be “n” in the decryption operation, S402, the MCU 16 commands the encryption-decryptor 15 to decrypt the data in the decryption operation, S403. Then the decrypted data are transmitted to the host 2 in the decryption operation, S404.

Where the value of the encryption key identification information added to the data by sector is confirmed not to be “n” in operation S402, the MCU 16 commands the encrypted data identification section 14 to substitute the data with “0” or an arbitrary value and transmit the data to the host 2 in operation S405. Alternatively, the encrypted data identification section 14 may not transmit the data because of the encryption key mismatch.

The data encrypted according to the old encryption key is protected because the encryption key update history information is added to the data by sector and not to transmit the data to the host 2. Alternatively, the data encrypted according to the old encryption key are substituted with “0” or the arbitrary value to default the data before being transmitted to the host 2. If data are not encrypted, the data could be invalid by changing encryption key update history information.

The magnetic disk apparatus according to the second embodiment of the present application re-encrypts data encrypted according to an old encryption key with a new encryption key. Hereinafter, the structure and operations of the magnetic disk apparatus in the second embodiment will be described.

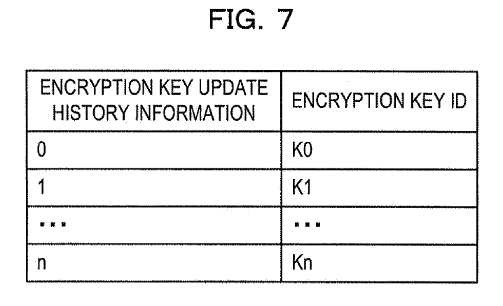

The structure of the magnetic disk apparatus in the second embodiment will be described. FIG. 7 is the encryption key update history table.

The magnetic disk apparatus 1 according to the first embodiment stores only the latest encryption key n and encryption key update history information n corresponding to the latest encryption key n in the system area of the medium 11. The encryption key update history table shown in FIG. 7 is stored in the system area of the medium 11 and provides the associations between the encryption key update history information of the encryption keys and encryption key IDs. Furthermore, all encryption keys corresponding to the encryption key IDs are stored after being encrypted in the system area.

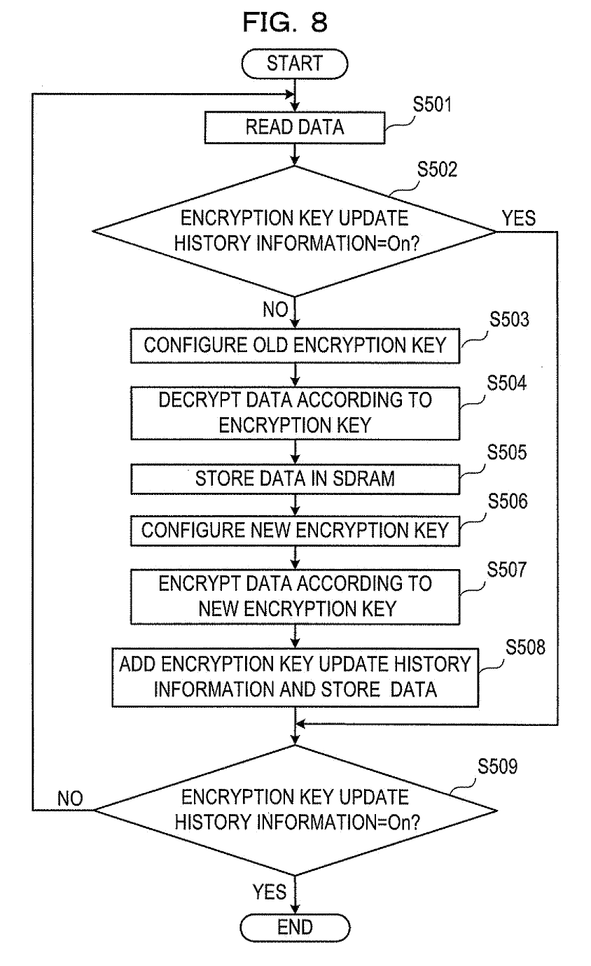

Next, re-encryption process in the second embodiment will be described. FIG. 8 is the flow chart of the re-encryption process. The magnetic disk apparatus in the second embodiment re-encrypts data upon receiving a re-encryption command issued by the host.

The MCU 16 reads data stored in sectors with the head 12 through the read channel 13 in the reading operation, S501. Then the encrypted data identification section 14 judges whether a value of encryption key identification information added to the data stored in the sectors are “n” to confirm whether the data are encrypted according to the latest encryption key in the judgment operation, S502.

Where the encryption key identification information is confirmed not to be “n” in the encryption key configuration operation, S502, the MCU 16 refers the encryption key identification table and configures the previous encryption key corresponding to the encryption key identification information in the encryption-decryptor 15 in the encryption key configuration operation, S503. The encryption-decryptor 15 decrypts the data stored in the sectors according to the old encryption key in the decryption operation, S504. The decrypted data are stored in the SDRAM 17 in the decryption operation, S505. Then a new encryption key is configured in the encryption-decryptor 15 in the encryption key configuration operation, S506. The data stored in the SDRAM 17 are encrypted according to the new encryption key in the encryption operation, S507. Encryption key identification information corresponding to the new encryption key is added by sector and stored in the read channel 13 in the storing operation, S508. Then the value of the encryption key update history information added to the data by sector is confirmed to be “n” or not in operation S509.

Where the value of the encryption key update history information is confirmed to be “n” in operation S509, the MCU 16 terminates the re-encryption process.

Where the value of the encryption key update history information is confirmed not to be “n” in operation S509, the MCU 16 reads the data with the head 12 through the reread channel 13 in operation S501.

Where the value of the encryption key identification information is confirmed to be “n” in operation S502, the MCU 16 judges whether the encryption key update history information added to the data is “n” in operation S509.

Accordingly, the magnetic disk apparatus 1 according to the second embodiment re-encrypts the data encrypted according to the old encryption key with the new encryption key. If the re-encryption process is interrupted, the re-encryption process is resumed from the sector where the process is interrupted with reference to the encryption key update history information added to the data. The magnetic disk apparatus 1 executes the re-encryption process shown in FIG. 8 upon receiving the re-encryption command. Alternatively, the re-encryption process may be executed each time the data encrypted according to the old encryption key are read. Where the data are re-encrypted in accordance with a new encryption key, the previous encryption key will be discarded for security.

The magnetic disk apparatus according to the third embodiment uses multiple encryption keys concurrently. The encryption key update history information and the encryption key type information are added to data by sector and stored in encrypting the data. The magnetic disk apparatus according to this embodiment selects an encryption key for decrypting the data from among the multiple encryption keys with reference to the encryption key type information added. Hereinafter, a structure of the magnetic disk apparatus according to the third embodiment and the encryption key identification process will be described.

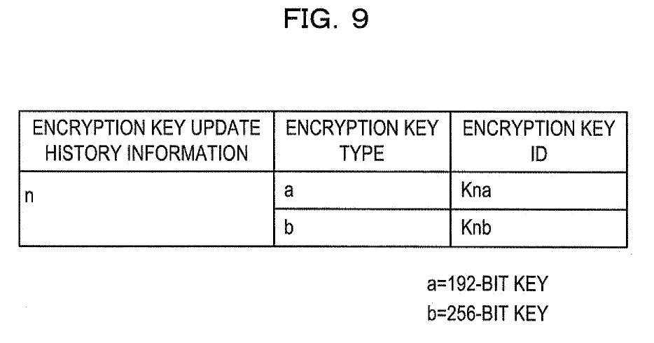

First, the encryption key type table will be described. FIG. 9 is the encryption key type table according to the third embodiment.

The encryption key type table stored in the system area of the medium 11 provides associations between the encryption keys, the latest encryption key update history information, the encryption key type information and encryption key IDs as shown in FIG. 9. “a” and “b” included in the encryption key type information represent a 192-bit key and a 256-bit key, respectively. The encryption keys are classified by bit length in the third embodiment. Alternatively, the encryption keys may be classified by encryption scheme and the encryption-decryptor 15 may be provided as much as the number of the encryption schemes.

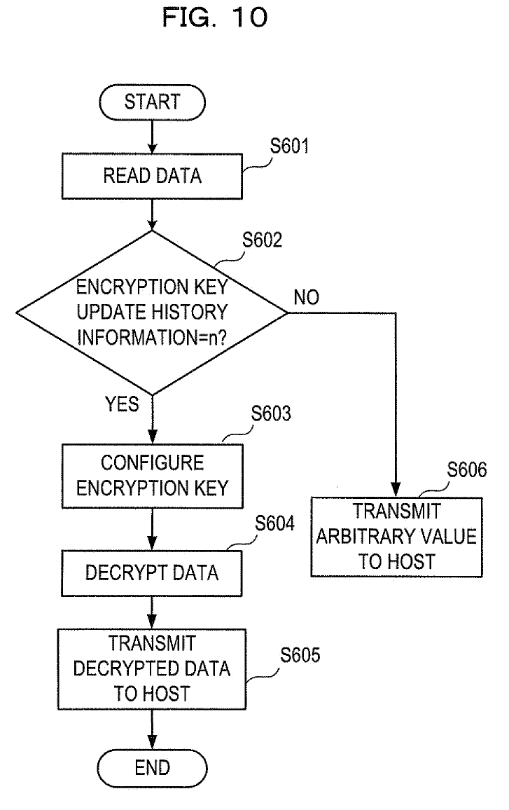

Next, the encryption key identification process according to the third embodiment will be discussed. FIG. 10 is the flow chart of the encryption key identification process in the third embodiment. The magnetic disk apparatus executes the encryption key identification process on receiving a command to require data issued by the host as shown in FIG. 10.

The MCU 16 reads data to which the encryption key update history information is added by sector from the medium with the head 12 through the read channel 13 in the reading operation, S601. The encrypted data identification section judges whether the value of the encryption key update history information added to the data by sector and the value of the encryption key update history information n configured in the HDC 1a are the same in the judgment operation, S602.

Where the value of the encryption key update history information added to the data is confirmed to be “n” in operation S602, the MCU 16 refers the encryption key type information added to the data and configures an encryption key corresponding to the encryption key type information in the encryption-decryptor 15 in the encryption key configuration operation, S603. In the decryption operation, S604, the encryption-decryptor 15 decrypts the data. Then the decrypted data are transmitted to the host 2 in the decryption operation, S605.

Where the value of the encryption key type information added to the data is confirmed not to be “n” in the operation S602, the MCU 16 commands the encrypted data identification section 14 to substitute the data with “0” or the arbitrary value and transmit the substituted data to the host 2 in operation S606. Alternatively, the encrypted data identification section 14 may not transmit the data because of the encryption key mismatch.

Accordingly, the magnetic disk apparatus 1 according in the third embodiment uses the encryption keys at different security levels in accordance with the data. The encryption keys are user-selectable in storing data.

Storage apparatuses applying different systems may be substituted with the magnetic disk apparatuses according to the embodiments described above.

Although a few preferred embodiments of the present application have been shown and described, it would be appreciated by those skilled in the art that changes may be made in these embodiments without departing from the principles and spirit of the application, the scope of which is defined in the claims and their equivalents.

1. A storage apparatus for storing data onto a recording medium, comprising:
an encryption key updater for configuring an updated encryption key and identification information thereof;
an encryptor for encrypting data by a specific unit according to the encryption key configured by the encryption key updater;
a storage for adding the identification information configured by the encryption key updater to the data encrypted by the encryptor and storing the encrypted data and the identification information onto the recording medium;
a reader for reading the encrypted data stored by the storage and the identification information added to the encrypted data;
a judge for judging whether the identification information added to the encrypted data read by the reader matches the identification information configured by the encryption key updater; and
a decryptor for decrypting the encrypted data according to the encryption key configured by the encryption key updater and outputting the decrypted data where the judge judges that the identification information added to the encrypted data by the encryptor matches the identification information configured by the encryption key updater.

2. The storage apparatus according to claim 1, further comprising:
an history updater for associating a latest encryption key configured by the encryption key updater with identification information thereof, and a previous encryption key with identification information thereof, and storing the latest encryption key and the previous encryption key and identification information thereof onto the recording medium as update history information.

3. The storage apparatus according to claim 2,
wherein the encryption key updater configures an encryption key corresponding to the identification information that matches the identification information added to the encrypted data included in the identification information stored onto the recording medium by the history updater where the judge judges that the identification information configured by the encryption key updater does not match the identification information added to the data encrypted by the encryptor,
wherein the decryptor decrypts the encrypted data according to the encryption key configured by the encryption key updater.

4. The storage apparatus according to claim 3,
wherein the encryption key updater configures the identification information added to the encrypted data and an encryption key corresponding to the identification information where the identification information of the latest encryption key stored onto the recording medium by the history updater does not match the identification information added to the encrypted data stored onto the recording medium by the storage,
wherein the decryptor decrypts the encrypted data according to the encryption key configured by the encryption key updater and stored the decrypted data in a memory,
wherein the encryption key updater configures a latest encryption key and identification information thereof and encrypts the data stored in the memory by the decryptor according to the latest encryption key configured by the encryption key updater, and
wherein the storage adds the identification information of the latest encryption key configured by the encryption key updater to the data encrypted by the encryptor and stores the encrypted data onto the recording medium.

5. The storage apparatus according to claim 1,
wherein the encryption key updater configures an encryption scheme and type information of an encryption key classified in accordance with the encryption scheme,
wherein the encryptor encrypts data according to the encryption key classified in accordance with the encryption scheme configured by the encryption key updater,
wherein a storage adds the identification information and the type information configured by the encryption key updater to the encrypted data stored by the encryptor and stores the encrypted data, the identification information and the type information onto the recording medium,
wherein the encryption key updater configures an encryption key corresponding to the type information added to the encrypted data where the judge judges that the identification information added to the encrypted data by the encryptor matches the identification information configured by the encryption key updater, and
wherein the decryptor decrypts the encrypted data according to the encryption key configured by the encryption key updater.

6. The storage apparatus according to claim 1,
wherein the recording medium is a magnetic disk.

7. The storage apparatus according to claim 1,
wherein the specific unit is a sector.

8. An encrypted data processing method for processing encrypted data stored onto a recording medium, comprising the operations of:
configuring an encryption key and identification information thereof;
reading data encrypted by a specific unit according to the encryption key configured in the encryption key configuration operation and added the identification information of the encryption key configured in the encryption key configuration operation from the recording medium;
judging whether the identification information of the encrypted data read in the reading operation matches the identification information configured in the encryption key configuration operation; and
decrypting the encrypted data according to the encryption key configured in the encryption key configuration operation and outputting the decrypted data where the identification information added to the encrypted data matches the identification information configured in the encryption key configuration operation.

9. The encrypted data processing method according to claim 8, further comprising an operation of:
associating the latest encryption key configured in the encryption key configuration operation with identification information of the latest encryption key, and the previous encryption key with identification information of the previous encryption key, and storing the latest encryption key, the previous encryption key and the identification information thereof onto the recording medium as update history.

10. The encrypted data processing method according to claim 9,
wherein the encryption key configuration operation configures identification information that matches the identification added to the encrypted data included in the identification information stored onto the recording medium in the update history operation and an encryption key corresponding to the identification information where the judgment operation judges that the identification information configured in the encryption key configuration operation matches the identification information added to the encrypted data, and
wherein the decryption operation decrypts the encrypted data according to the encryption key configured in the encryption key configuration operation.

11. The encrypted data processing method according to claim 10, further comprising the operations of:
encrypting the data stored in the memory in the decryption operation according to the latest encryption key configured in the encryption key configuration operation; and
adding the identification information of the latest encryption key configured in the encryption key configuration operation to the data encrypted in the encryption operation and storing the encrypted data onto the recording medium,
wherein the encryption key configuration operation configures the identification information added to the encrypted data and an encryption key corresponding to the identification information where the judgment operation judges that the identification information of the latest encryption key stored onto the recording medium in the update history operation does not match the identification information added to the encrypted data stored onto the recording medium,
wherein the decryption operation decrypts the encrypted data according to the encryption key configured in the encryption key configuration operation and stores the decrypted data in a memory, and
wherein the encryption key configuration operation configures a latest encryption key and identification information thereof.

12. The encrypted data processing method according to claim 8,
wherein the encryption key configuration operation configures an encryption scheme and type information of an encryption key classified in accordance with the encryption scheme,
wherein the encryption key configuration operation configures an encryption key corresponding to the type information added to the encrypted data where the judgment operation judges that the identification information added to the encrypted data matches the identification information configured in the encryption key configuration operation, and
wherein the decryption operation decrypts the encrypted data according to the encryption key configured in the encryption key configuration operation.

13. The encrypted data processing method according to claim 8,
wherein the recording medium is a magnetic disk.

14. The encrypted data processing method according to claim 8,
wherein the specific unit is a sector.
